(19) United States
(12) Patent Application Publication
(10) Pub. No.: US 2025/0139544 A1
(43) Pub. Date: May 1, 2025

(54) ENTERPRISE CONFIGURATION ONBOARDING IN A CLOUD SYSTEM LANDSCAPE USING PROJECT LINE

(71) Applicant: SAP SE, Walldorf (DE)

(72) Inventor: Manfred HEROLD, Bad Schoenborn (DE)

(21) Appl. No.: 18/496,050

(22) Filed: Oct. 27, 2023

(51) Int. Cl. G06Q 10/0631

(52) U.S. Cl. CPC G06Q 10/06313

(57) ABSTRACT

A system may include a provider server that is associated with a provider of a cloud computing environment. The provider server may receive, from a tenant, customized enterprise configuration information associated with an onboarding process (e.g., a customized business configuration). The provider server may then create an original system in the cloud computing environment for the customized enterprise configuration information. The tenant may develop and test the customized enterprise configuration information via a project line of the original configuration before being taken over into a main line. Moreover, the project line can be changed by being reset by the tenant (e.g., without action by the provider) while changes to the main line (e.g., to correct mistakes) require that the provider provision another system for the tenant.

### BACKGROUND

An enterprise may utilize a cloud computing environment to let users perform tasks. For example, the enterprise might let various users execute applications via the cloud computing environment to process purchase orders, adjust human resources information, generate invoices, etc. In some cases, a provider of the cloud computing environment will support multiple customers or tenants who are able to customize parameters, such as a business configuration, for a cloud Enterprise Resource Planning (“ERP”) system landscape. For example, the customer might define a preferred currency, a fiscal year definition, etc. during an onboarding process. Typically, these customizations are implemented by having the provider provision a system to be used for development, testing, and, eventually, a production environment. Mistakes in the customizations may require that the provider provision an entirely new system for the customer, which can be a time consuming and costly process for both the customer and the provider.

It would therefore be desirable to provide an onboarding process that allows customization corrections without provisioning a new system for a tenant of a cloud computing environment in a secure, automatic, and efficient manner.

### SUMMARY

According to some embodiments, methods and systems associated with a cloud computing environment may include a provider server that is associated with a provider of a cloud computing environment. The provider server may receive, from a tenant, customized enterprise configuration information associated with an onboarding process (e.g., a customized business configuration). The provider server may then create an original system in the cloud computing environment for the customized enterprise configuration information. The tenant may develop and test the customized enterprise configuration information via a project line of the original configuration before being taken over into a main line. Note that only the main line might be associated with a production system. Moreover, the project line can be changed by being reset by the tenant (e.g., without action by the provider) while changes to the main line (e.g., to correct mistakes) require that the provider provision another system for the tenant.

Some embodiments comprise: means for receiving, by a computer processor of a tenant server from a tenant at a provider of the cloud computing environment, customized enterprise configuration information associated with an onboarding process; means for creating an original system in the cloud computing environment for the customized enterprise configuration information; and means for arranging for the tenant to develop and test the customized enterprise configuration information via a project line of the original configuration before being taken over into a main line, wherein the project line can be changed by being reset by the tenant, without action by the provider, while changes to the main line require that the provider provision another system for the tenant. Some embodiments further include: means for receiving, from the tenant, an indication that the project line of the original configuration is correct; and responsive to the received indication, means for taking the customized business configuration over into the main line.

Some technical advantages of some embodiments disclosed herein are improved systems and methods to provide an onboarding process that allows customization corrections without provisioning a new system for a tenant of a cloud computing environment in a secure, automatic, and efficient manner.

### BRIEF DESCRIPTION OF THE DRAWINGS

FIG. 1 is an example of an onboarding system landscape.

FIG. 2 is a main line onboarding process.

FIG. 3 is an onboarding system landscape with a project line according to some embodiments.

FIG. 4 is another example of an onboarding process.

FIG. 5 is an onboarding process with a project line according to some embodiments.

FIG. 6 is an onboarding process with both a project line and a main line in accordance with some embodiments.

FIG. 7 is a method according to some embodiments.

FIG. 8 is high-level system architecture according to some embodiments.

FIG. 9 is a project line customization display in accordance with some embodiments.

FIG. 10 is an apparatus or platform according to some embodiments.

FIG. 11 is a portion of an onboarding data store in accordance with some embodiments.

FIG. 12 illustrates a tablet computer according to some embodiments.

FIG. 13 is an operator or administrator display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

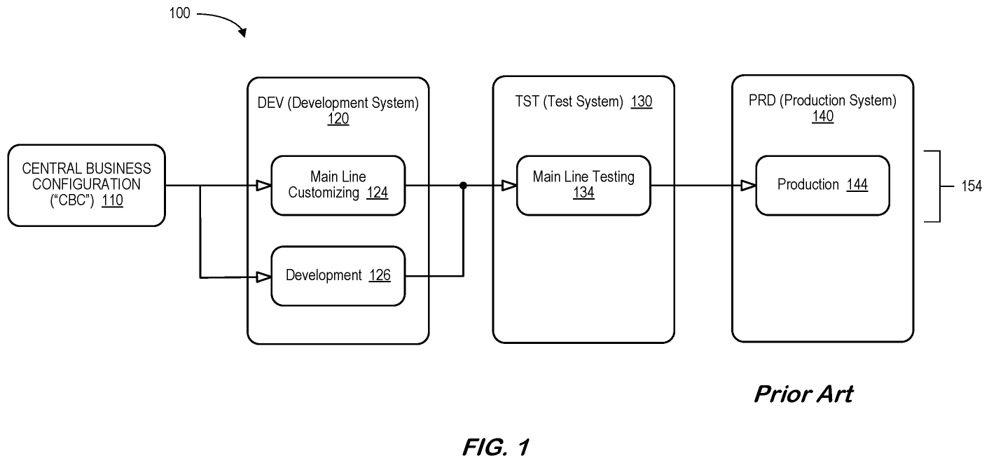

A provider of a cloud computing environment may support multiple customers or tenants who are able to customize parameters, such as a business configuration, for a cloud ERP system landscape. For example, FIG. 1 is an example of an onboarding system landscape 100. By way of example only, the landscape 100 maybe associated with the SAP™ S/4HANA® system. The S/4HANA® system is an ERP software package used to integrate and manage business functions—such as finance, human resources, procurement, sales, manufacturing, and service—in substantially real time. Such a landscape may provide improved productivity by letting businesses automate manual processes which leads to increased efficiency. The landscape 100 may also reduce Information Technology (“IT”) costs by using a simplified data model and streamlined architecture to reduce the complexity of the software.

The landscape 100 includes a Central Business Configuration (“CBC”) 110 where a customer might define a preferred currency, a fiscal year definition, etc. during an onboarding process. These customizations are implemented by having the provider provision a system to be used by a development (“DEV”) system 120, a test (“TST”) system 130, and, eventually, a production (“PRD”) system 140. The central business configuration 110 may be used for main line customizing 124 and development 126 in the development system 120 before being used for main line testing 134 in the test system 130 and production 144 in the production system 140. Together, the main line customizing 124, main line testing 134, and production 144 are referred to as the “main line” 154. Note that the system landscape 100 forces the customer to start the business configuration in the main line 154. Starting in development 126 is not desirable because the customization in the development line is only local (that is, it cannot be transferred to another tenant).

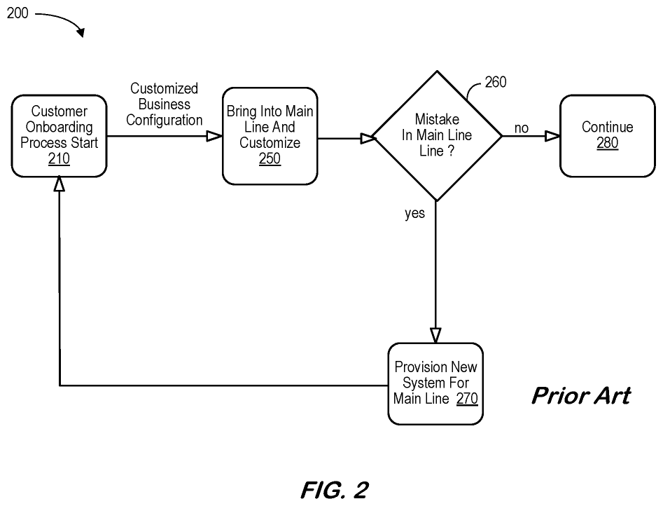

FIG. 2 is a main line onboarding process 200. After starting the customer onboarding process 210, the customized business configuration is brought into the main line and customized 250. Note that a re-build of a customer system will be needed when a mistake occurs in main line customizing. For example, if a customer does a wrong configuration (e.g., uses the wrong fiscal year variant or incorrect chart of account, etc.) the only solution is to provision the customer one or more entirely new systems (also known as “reprovisioning”) and the configuration starts again from the beginning. That is, if there is a main line mistake 260, the cloud provider needs provision one or more new systems for the main line 270 (e.g., in some cases three new systems might need to be provisioned). This procedure incurs costs for both the cloud provider (provisioning of new systems and decommissioning of old systems) and on the customer side (redoing system onboarding, configuration, integration, development, etc.). The original system and the new system will also be associated with different Uniform Resource Locators (“URLs”) further complicating the process 200. Moreover, for the reprovisioning alignment is needed between the customer and the cloud provider (so it not only expensive but also lowers the Net Promoter Score (“NPS”)). When there is no main line mistake 260, the process 200 can continue 280.

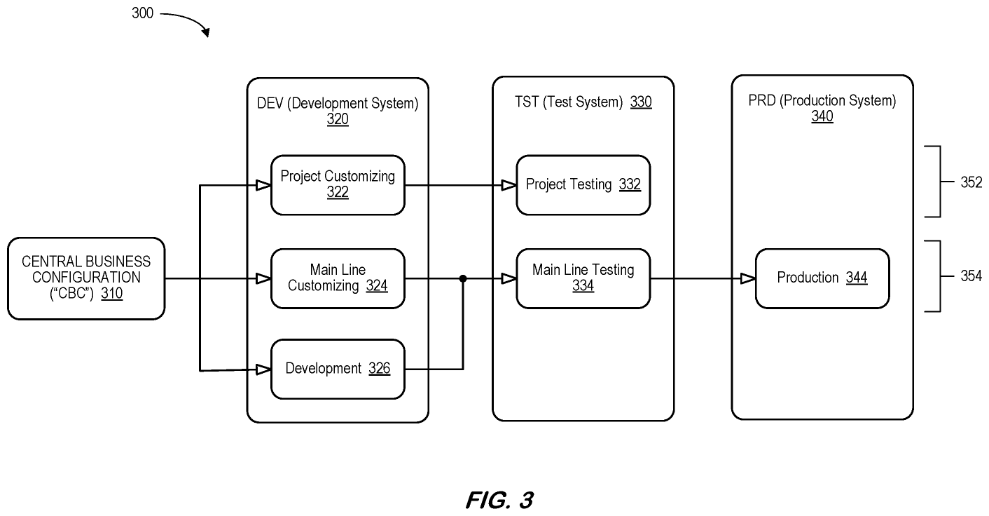

FIG. 3 is an onboarding system landscape 300 with a project line according to some embodiments. As before, the landscape 300 includes a central business configuration 310 where a customer or tenant might define a preferred currency, a fiscal year definition, etc. during an onboarding process. These customizations are implemented by having the provider provision a system to be used by a development system 320, a test system 330, and, eventually, a production system 340. The central business configuration 310 may be used for main line customizing 324 and development 326 in the development system 320 before being used for main line testing 334 in the test system 330 and production 344 in the production system 340. Together, the main line customizing 324, main line testing 334, and production 344 are referred to as the “main line” 354.

In this landscape, however, an additional “project line” 352 is added including project customizing 322 in the development system 320 and project testing 332 in the test system 330. In contrast to the main line 354, the project line 352 can be reset (also known as “rebuilding” and/or “clearing”). With this capability, the customer can perform customized configurations again and again without involving the cloud provider. The already known URLs remain the same and client-independent objects (e.g., development) remain in the system as well.

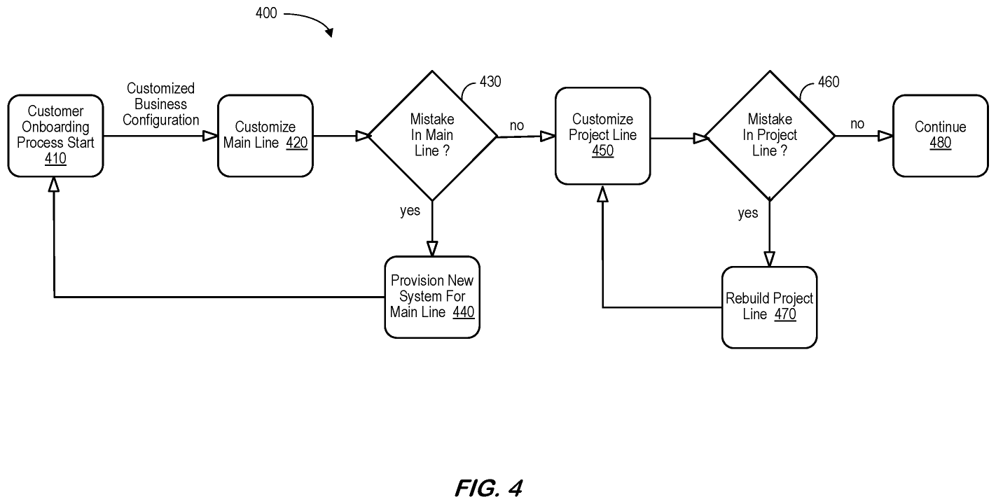

Once again, the system landscape 300 forces the customer to start the business configuration in the main line 354. For example, FIG. 4 is another example of an onboarding process 400. After starting the customer onboarding process 410, the customized business configuration is brought into the main line and customized 420. Note that a re-build of a customer system is still needed when a mistake occurs in main line customizing. That is, if there is a main line mistake 430, the cloud provider needs provision a new system for the main line 440. When there is no mistake in the main line 430, the customizations may be used to customize the project line 450. Any mistakes in the project line 460 can be addressed by simply rebuilding the project line 470 (without involving the cloud provider) until no mistakes are found 460 and the process 400 may continue 480. Note that customers are again forced to start in the main line and a closed main line is a pre-requisite to use of the project line. As a result, the risk that new systems will need to be provisioned 440 remains substantial.

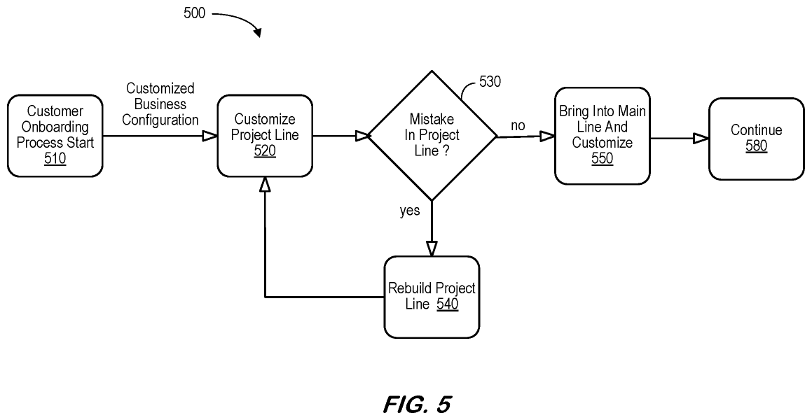

To reduce this risk, FIG. 5 is an onboarding process 500 that might be applied to a project line according to some embodiments. In this case, the system landscape does not force the customer to start the business configuration in the main line. Instead, after starting the customer onboarding process 510, the customized business configuration is brought into the project line and customized 520. As a result, if there is a project line mistake 530, the tenant can simply rebuild the project line 540 (without involving the cloud provider) and continue to customize the project line 520. When no project line mistake 530 is found, the customization is brought into the main line for further customization 550 and the process 500 may continue 580. Because customers are not forced to start in the main line, the risk that new systems will need to be provisioned is substantially reduced.

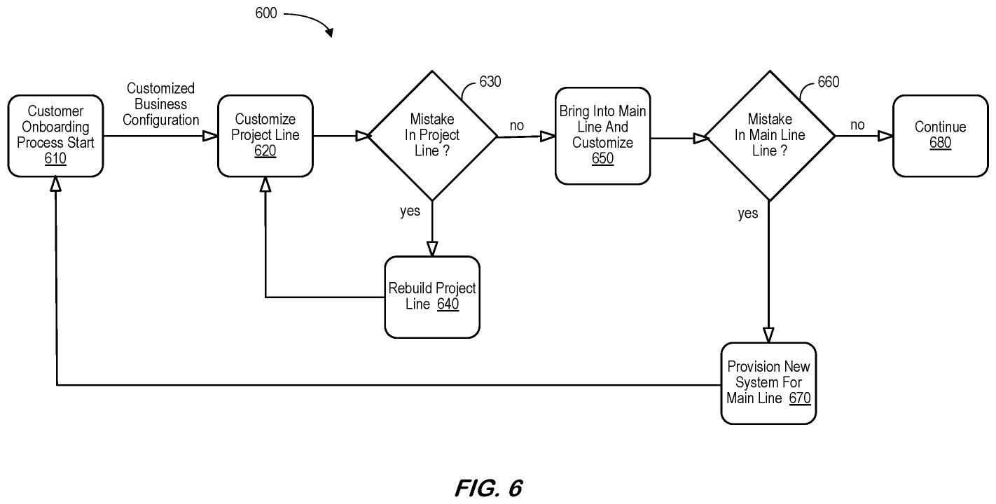

Even when starting in the project line, an eventual provisioning of a new system might still be required. For example, FIG. 6 is an onboarding process 600 with both a project line and a main line in accordance with some embodiments. After starting the customer onboarding process 610, the customized business configuration is brought into the project line and customized 620. If there is a project line mistake 630, the tenant can simply rebuild the project line 640 (without involving the cloud provider) and continue to customize the project line 620. When no project line mistake 630 is found, the customization is brought into the main line for further customization 650. That is, once the customer is confident that the configuration fits the business needs (e.g., after performing tests in the test system 330 described with respect to FIG. 3), the initial business configuration can be taken over into the main line. If there is a main line mistake 660 at this point, a new system will need to be provisioned 670 by the cloud provider, and the process 600 will start over 610. When no main line mistake 660 is found, the process 600 can continue 680. Even though a new system may need to be provisioned 670 in some cases, the risk of that occurring is substantially reduced (because most customization mistakes will be found in the project line). Note that the process 600 may be applied to small or large business configuration change projects.

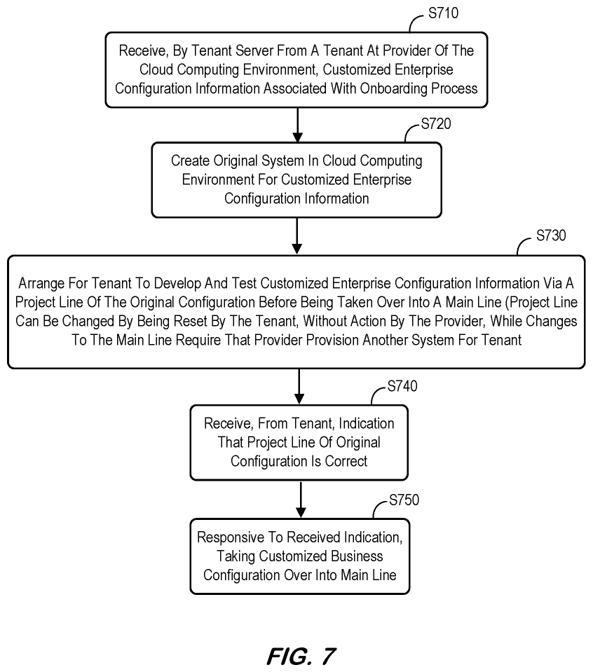

FIG. 7 is a method that might be performed according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S710, a tenant server may receive (from a tenant of a provider of a cloud computing environment) customized enterprise configuration information associated with an onboarding process. The cloud computing environment might be associated with, for example, a cloud ERP system landscape and the customized enterprise configuration information may comprise a customized business configuration. According to some embodiments, the onboarding process is associated with a development system, a test system, and/or a production system.

At S720, an original system in the cloud computing environment is created for the customized enterprise configuration information. The tenant server may then, at S730, arrange for the tenant to develop and test the customized enterprise configuration information via a project line of the original configuration before being taken over into a main line. The project line may be changed by being reset by the tenant (without action by the provider), while changes to the main line require that the provider provision another system for the tenant. According to some embodiments, provisioning another system for the tenant is associated with creation of a new URL while resetting the project line does not. Moreover, client-independent objects may remain after a project reset. In addition, changes to the main line may further require that the cloud provider decommission the original system. At S740, an indication is received, from the tenant, that the project line of the original configuration is correct. Responsive to the received indication, the customized business configuration is taken over into the main line at S750.

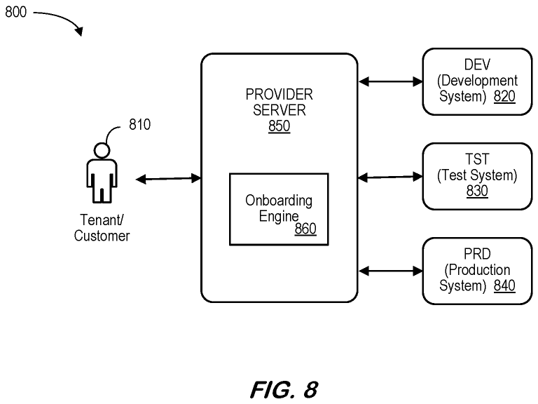

FIG. 8 is a high-level block diagram of one example of a system 800 that provides an integration service. In particular, tenant or customer 810 may exchange information with a provider server 850 (e.g., as part of an onboard process for business configuration information). The provider server 850 may include an onboarding engine 860 and communicate with a development system 820, a test system 830, and a production system 840. According to some embodiments, a remote operator or administrator device may be used to configure or otherwise adjust the system 800.

As used herein, devices, including those associated with the system 800 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The provider server 850 may store information into and/or retrieve information from various data stores (e.g., an onboarding data store), which may be locally stored or reside remote from the provider server 850. Although a single provider server 850 is shown in FIG. 8, any number of such devices may be included. Moreover, various devices described herein might be combined according to embodiments of the present invention. The system 800 functions may be performed by a constellation of networked apparatuses, such as in a distributed processing or cloud-based architecture.

The integration developer may access the system 800 via a remote device (e.g., a Personal Computer (“PC”), tablet, or smartphone) to view information about and/or manage operational information in accordance with any of the embodiments described herein. In some cases, an interactive Graphical User Interface (“GUI”) display may let an operator or administrator define and/or adjust certain parameters via a remote device (e.g., to specify how an onboarding process will proceed) and/or provide or receive automatically generated recommendations, alerts, or results associated with the system 800.

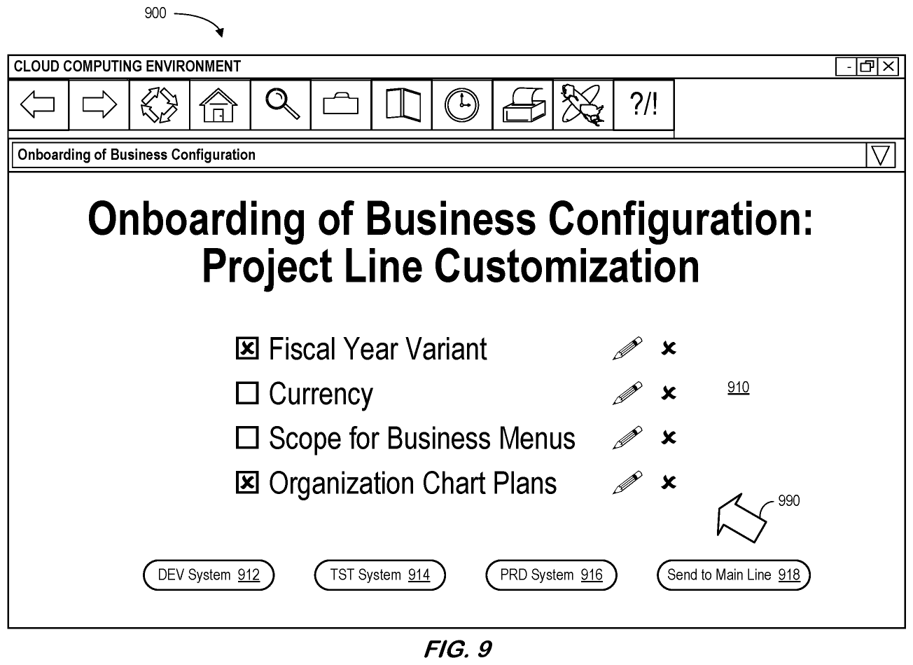

FIG. 9 is a project line customization display 900 in accordance with some embodiments. The display 900 includes a list 910 of possible customizations to a business configuration. The user selects items in the list 910 (e.g., via touchscreen or computer mouse pointer 990) to begin to edit or revise the customizations. The user can also select a “DEV System” icon 912, a “TST System” icon 914, and a “PRO System” icon 916 to access additional information about those systems. When the customizations are complete, the tenant may select a “Send to Main Line” icon 918 to send the information to the main line for continue the onboarding process.

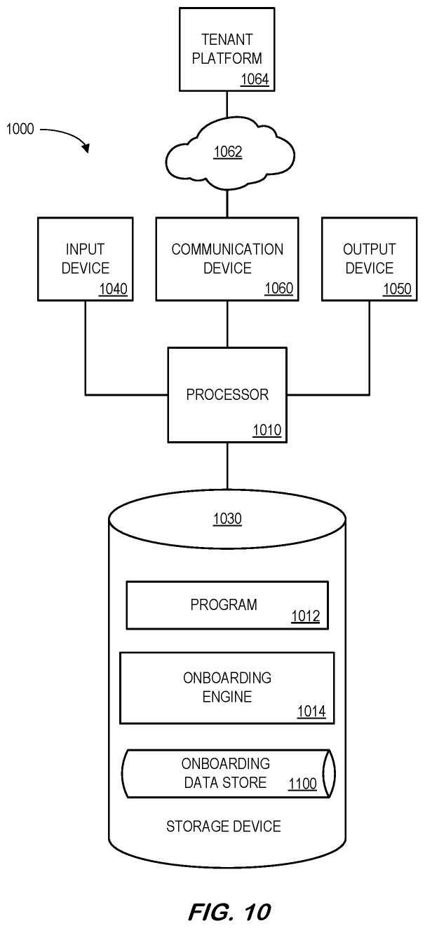

Note that the embodiments described herein may be implemented using any number of different hardware configurations. For example, FIG. 10 is a block diagram of an apparatus or platform 1000 that may be, for example, associated with the systems 300, 800 of FIGS. 3 and 8, respectively (and/or any other system described herein). The platform 1000 comprises a processor 1010, such as one or more commercially available Central Processing Units (“CPUs”) in the form of one-chip microprocessors, coupled to a communication device 1060 configured to communicate via a communication network 1062. The communication device 1060 may be used to communicate, for example, with one or more remote tenant 1064 platforms, administrator platforms, etc. The platform 1000 further includes an input device 1040 (e.g., a computer mouse and/or keyboard to input mappings and/or business configuration customizations) and/or an output device 1050 (e.g., a computer monitor to render a display, transmit recommendations and alerts, and/or create reports about onboarding, validation results, tenants, customers, etc.).

The processor 1010 also communicates with a storage device 1030. The storage device 1030 may comprise any appropriate information storage device, including combinations of magnetic storage devices (e.g., a hard disk drive), optical storage devices, mobile telephones, and/or semiconductor memory devices. The storage device 1030 stores a program 1012 and/or onboarding engine 1014 for controlling the processor 1010. The processor 1010 performs instructions of the programs 1012, 1014, and thereby operates in accordance with any of the embodiments described herein. For example, the processor 1010 may receive, from a tenant, customized enterprise configuration information associated with an onboarding process (e.g., a customized business configuration). The processor 1010 may then create an original system in the cloud computing environment for the customized enterprise configuration information. The tenant may develop and test the customized enterprise configuration information via a project line of the original configuration before being taken over into a main line by the processor 1010. Moreover, the project line can be changed by being reset by the tenant (e.g., without action by the provider) while changes to the main line require that the processor 1010 provision another system for the tenant.

The programs 1012, 1014 may be stored in a compressed, uncompiled and/or encrypted format. The programs 1012, 1014 may furthermore include other program elements, such as an operating system, clipboard application, a database management system, and/or device drivers used by the processor 1010 to interface with peripheral devices.

As used herein, information may be “received” by or “transmitted” to, for example: (i) the platform 1000 from another device; or (ii) a software application or module within the platform 1000 from another software application, module, or any other source.

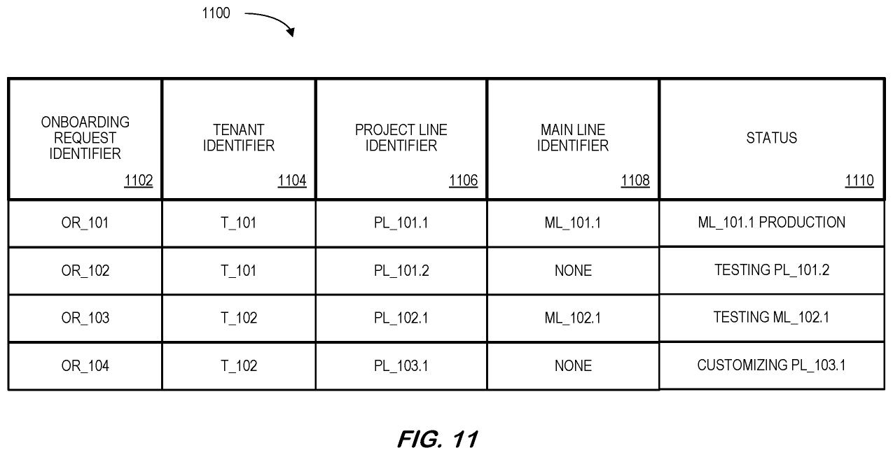

In some embodiments (such as the one shown in FIG. 10), the storage device 1030 further stores an onboarding data store 1100. An example of a database that may be used in connection with the platform 1000 will now be described in detail with respect to FIG. 11. Note that the database described herein is only one example, and additional and/or different information may be stored therein. Moreover, various databases might be split or combined in accordance with any of the embodiments described herein.

Referring to FIG. 11, a table is shown that represents the onboarding data store 1100 that may be stored at the platform 1000 according to some embodiments. The table may include, for example, entries identifying requests from a tenant to onboard a business configuration associated with a cloud computing environment. The table may also define fields 1102, 1104, 1106, 1108, 1110 for each of the entries. The fields 1102, 1104, 1106, 1108, 1110 may, according to some embodiments, specify: an onboarding request identifier 1102, a tenant identifier 1104, project line identifier 1106, a main line identifier 1108, and a status 1110. The onboarding data store 1100 may be created and updated, for example, when a new tenant request is received, customizations are complete, etc.

The onboarding request identifier 1102 might be a unique alphanumeric label that is associated with a particular request associated with a central business configuration. The tenant identifier 1104 may indicate a customer who provided the request and the project line identifier 1106 might indicate where customizations began in an onboarding system landscape. When the project line customizations are complete, the main line identifier 1108 may indicate where the customizations were brought from the project line into the main line (e.g., for further development and testing). The status 1110 might indicate that the onboarding request is being customized, is being tested, has been sent to a production system, etc.

In this way, embodiments may improve a business configuration onboarding process for a tenant and a provider of a cloud computing environment. In particular, the tenant may catch customization mistakes in the project line and correct them without needing to involve the cloud provider.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

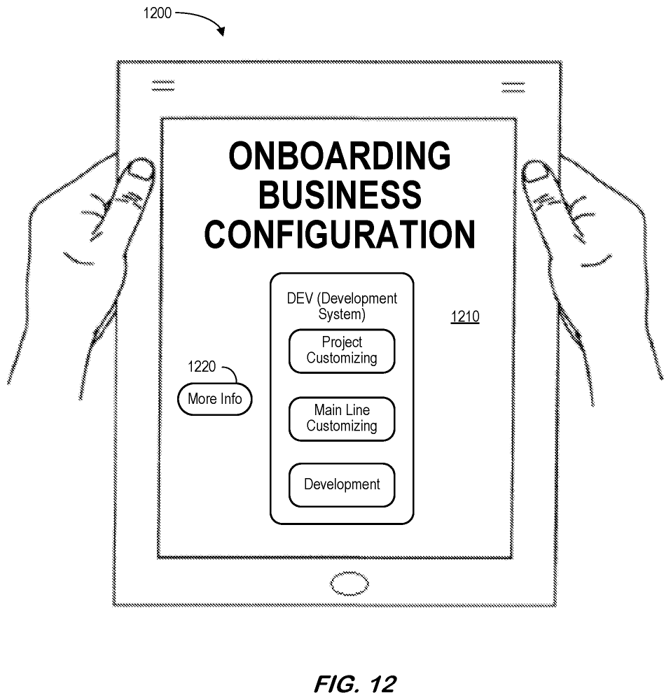

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of business configurations, any of the embodiments described herein could be applied to other types of business configurations. Moreover, the displays shown herein are provided only as examples, and any other type of user interface could be implemented. For example, FIG. 12 illustrates a tablet computer 1200 providing a business configuration onboarding display 1210. The display 1210 might be used, for example, to modify aspects of a test system, a development system, etc. via selection of a “More Info” icon 1220.

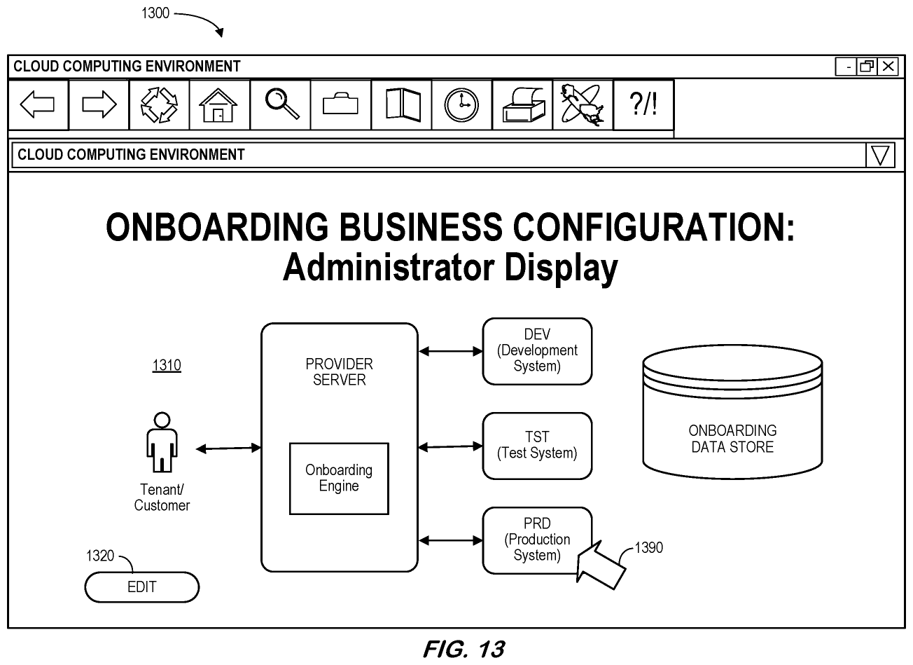

FIG. 13 is an operator or administrator display in accordance with some embodiments. The display 1300 includes a graphical representation 1310 of an onboarding system in accordance with any of the embodiments described herein. Selection of an element on the display 1300 (e.g., via a touchscreen or computer pointer 1390) may result in display of a pop-up window containing more detailed information about that element and/or various options (e.g., business configuration details, requests to rebuild a project line, requests to provision a new system, etc.). Selection of an “Edit” icon 1320 may also let an operator or administrator adjust the operation of the system (e.g., to change system mappings, adjust an onboarding data store, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system associated with a cloud computing environment, comprising:
a provider server, associated with a provider of the cloud computing environment, including:
a computer processor, and
a computer memory storing instructions that, when executed by the computer processor, cause the provider server to:
receive, from a tenant, customized enterprise configuration information associated with an onboarding process,
create an original system in the cloud computing environment for the customized enterprise configuration information, and
arrange for the tenant to develop and test the customized enterprise configuration information via a project line of the original configuration before being taken over into a main line, wherein the project line can be changed by being reset by the tenant, without action by the provider, while changes to the main line require that the provider provision another system for the tenant.

2. The system of claim 1, wherein the cloud computing environment is associated with a cloud Enterprise Resource Planning (“ERP”) system landscape.

3. The system of claim 2, wherein the customized enterprise configuration information comprises a customized business configuration.

4. The system of claim 3, wherein the provider server is further to:
receive, from the tenant, an indication that the project line of the original configuration is correct, and
responsive to the received indication, take the customized business configuration over into the main line.

5. The system of claim 1, wherein provisioning another system for the tenant is associated with creation of a new Uniform Resource Locator (“URL”) while resetting the project line does not.

6. The system of claim 5, wherein client-independent objects remain after a project reset.

7. The system of claim 6, wherein changes to the main line further require that the provider decommission of the original system.

8. The system of claim 1, wherein the onboarding process is associated with a development system, a test system, and a production system.

9. A computer-implemented method associated with a cloud computing environment, comprising:
receiving, by a computer processor of a tenant server from a tenant at a provider of the cloud computing environment, customized enterprise configuration information associated with an onboarding process;
creating an original system in the cloud computing environment for the customized enterprise configuration information; and
arranging for the tenant to develop and test the customized enterprise configuration information via a project line of the original configuration before being taken over into a main line, wherein the project line can be changed by being reset by the tenant, without action by the provider, while changes to the main line require that the provider provision another system for the tenant.

10. The method of claim 9, wherein the cloud computing environment is associated with a cloud Enterprise Resource Planning (“ERP”) system landscape.

11. The method of claim 10, wherein the customized enterprise configuration information comprises a customized business configuration.

12. The method of claim 11, further comprising:
receiving, from the tenant, an indication that the project line of the original configuration is correct; and
responsive to the received indication, taking the customized business configuration over into the main line.

13. The method of claim 9, wherein provisioning another system for the tenant is associated with creation of a new Uniform Resource Locator (“URL”) while resetting the project line does not.

14. The method of claim 13, wherein client-independent objects remain after a project reset.

15. The method of claim 14, wherein changes to the main line further require that the provider decommission of the original system.

16. The method of claim 9, wherein the onboarding process is associated with a development system, a test system, and a production system.

17. A non-transitory, machine-readable medium comprising instructions thereon that, when executed by a processor, cause the processor to execute operations to perform a method associated with a cloud computing environment, the method comprising:
receiving, by a computer processor of a tenant server from a tenant at a provider of the cloud computing environment, customized enterprise configuration information associated with an onboarding process;
creating an original system in the cloud computing environment for the customized enterprise configuration information; and
arranging for the tenant to develop and test the customized enterprise configuration information via a project line of the original configuration before being taken over into a main line, wherein the project line can be changed by being reset by the tenant, without action by the provider, while changes to the main line require that the provider provision another system for the tenant.

18. The medium of claim 17, wherein the cloud computing environment is associated with a cloud Enterprise Resource Planning (“ERP”) system landscape.

19. The medium of claim 18, wherein the customized enterprise configuration information comprises a customized business configuration.

20. The medium of claim 19, wherein execution of the instructions by the processor further cause the processor to:
receive, from the tenant, an indication that the project line of the original configuration is correct; and
responsive to the received indication, take the customized business configuration over into the main line.
